(19) United States
(12) Patent Application Publication
(10) Pub. No.: US 2015/0279232 A1
(43) Pub. Date: Oct. 1, 2015

(54) GARMENTS FOR EVALUATING ATHLETIC POSTURE

(71) Applicants: Amy Pearce Hayden, Holmes, NY (US); Leslie Bernstein, Carmel, NY (US)

(72) Inventors: Amy Pearce Hayden, Holmes, NY (US); Leslie Bernstein, Carmel, NY (US)

(21) Appl. No.: 14/675,279

(22) Filed: Mar. 31, 2015

Related U.S. Application Data
(60) Provisional application No. 61/973,426, filed on Apr. 1, 2014.

(51) Int. Cl. G09B 19/00; A41B 1/08; A41D 1/08

(52) U.S. Cl. CPC G09B 19/0038; A41D 1/08; A41B 1/08

(57) ABSTRACT

Disclosed is a garment for facilitating bodily posture including a base fabric and at least one reference line disposed on at least a portion of the base fabric that is configured to indicate proper bodily posture in at least one position. The at least one position can include a plurality of yoga positions.

### CROSS-REFERENCE TO RELATED APPLICATIONS

This application claims priority to U.S. Provisional Application Ser. No. 61/973,426 filed on Apr. 1, 2014. The entire contents of this application is hereby incorporated by reference herein.

### BACKGROUND OF THE INVENTION

1. Field of the Invention

This disclosure generally relates to athletic clothing and more particularly to garments for evaluating athletic or restorative posture during a yoga session or other posture based athletics/exercises.

2. Background of the Related Art

Long-term yoga practitioners in the United States have reported musculoskeletal and mental health improvements, as well as reduced symptoms of asthma in asthmatics. Regular yoga practice increases brain GABA levels and has been shown to improve mood and anxiety more than some other metabolically matched exercises, such as walking. The three main focuses of Hatha yoga (exercise, breathing, and meditation) make it beneficial to those suffering from heart disease, various muscular structural conditions and is found supportive for stress and anxiety reduction. Overall, studies of the effects of yoga on heart disease suggest that yoga may reduce high blood pressure, improve symptoms of heart failure, enhance cardiac rehabilitation, and lower cardiovascular risk factors.

Yoga practitioners without proper instruction or skilled guidance in proper alignment each year suffer physical injuries analogous to sports injuries for several reasons. For example, torn muscles and knee injuries are common ailments which may result from improper yoga practice.

Among the main reasons that experts cite for causing negative effects from yoga are beginners' competitiveness and instructors' lack of qualification. As the demand for yoga classes grows, many people get certified to become yoga instructors, often with relatively little training. Not every newly certified instructor can evaluate the condition of every new trainee in their class and recommend refraining from doing certain poses or using appropriate props to avoid injuries. In turn, a beginning yoga student can overestimate the abilities of their body and strive to do advanced poses before their body is flexible or strong enough to perform them. Often times, beginners and poorly qualified instructors are unaware that the posture of the student is incorrect.

Accordingly, a need exists to provide beginners and instructors alike with a way to increase safety of performing and teaching yoga poses that rely on proper posture.

### SUMMARY OF THE INVENTION

The purpose and advantages of the invention will be set forth in and apparent from the description that follows. Additional advantages of the invention will be realized and attained by the systems and methods particularly pointed out in the written description and claims hereof, as well as from the appended drawings.

To achieve these and other advantages and in accordance with the purpose of this disclosure, the herein described garment includes, in one aspect at least one reference line that is configured to indicate proper posture for one or more yoga positions.

In at least one aspect of this disclosure, a garment for facilitating bodily posture includes a base fabric and at least one reference line disposed on at least a portion of the base fabric that is configured to indicate proper bodily posture in at least one position. In some embodiments, the at least one reference line can be a seam on the fabric. The at least one position can include a plurality of yoga positions.

In some embodiments, the garment further has at least one fabric insert connected to the base fabric. The fabric insert can be connected to the base fabric by a seam and/or be visually separated from the base fabric by the at least one reference line. The reference line and the base fabric can contrast in color. It is also envisioned that the fabric insert contrasts from one or both of the base fabric and the reference line.

The garment can be a shirt and can further include a torso portion and two sleeves. In such embodiments, the at least one reference line can have a reference line in the center of the torso portion. Further, the at least one reference line can include a pair of reference lines on each sleeve. In some embodiments, the reference lines of the pair of reference lines on each sleeve may converge toward each other at an elbow section of the sleeve and diverge from each other at a wrist portion and a shoulder portion of the sleeve.

The garment can also be a pair of pants that includes a waist portion and two leg portions. In such embodiments, the at least one reference line can include a front leg reference line on each leg portion extending from the waist portion to an ankle portion of each leg portion along a front centerline of the leg portion. Alternatively or conjunctively, the at least one reference line can include a side leg reference line on each leg portion extending from the waist portion to an ankle portion of each leg portion along a side centerline of the leg portion.

### BRIEF DESCRIPTION OF THE DRAWINGS

So that those having ordinary skill in the art to which the present invention pertains will more readily understand how to employ the systems and methods of the present invention, embodiments thereof will be described in detail hereinbelow with reference to the drawings, wherein:

FIG. 1 illustrates a frontal view of an embodiment of a garment in accordance with this disclosure;

FIG. 2 illustrates a rear view of the embodiment of FIG. 1;

FIG. 3 illustrates a side view of the embodiment of FIG. 1;

FIG. 4 illustrates a front view of another embodiment of a garment in accordance with this disclosure;

FIG. 5 illustrates a rear view of the embodiment of FIG. 4;

FIG. 6 illustrates a front view of another embodiment of a garment in accordance with this disclosure;

FIG. 7 illustrates a rear view of the embodiment of FIG. 6;

FIG. 8 illustrates a front view of another embodiment of a garment in accordance with this disclosure;

FIG. 9 illustrates a rear view of the embodiment of FIG. 8;

FIG. 10 illustrates a side view of the embodiment of FIG. 8.

FIG. 11 illustrates a user wearing the embodiments of FIGS. 1-5 in a yoga pose; and

FIG. 12 illustrates a user wearing the embodiments of FIGS. 6-10 in a yoga pose.

These and other aspects of the subject disclosure will become more readily apparent to those having ordinary skill in the art from the following detailed description of the invention taken in conjunction with the drawings.

### DETAILED DESCRIPTION OF CERTAIN EMBODIMENTS

Embodiments of this disclosure are now described more fully with reference to the accompanying drawings, in which an illustrated embodiment is shown. This disclosure is not limited in any way to the illustrated embodiment as the illustrated embodiment described below is merely an example which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the embodiments disclosed herein. Furthermore, the terms and phrases used herein are not intended to be limiting but rather to provide an understandable description of the embodiments herein.

Where a range of values is provided, it is understood that each intervening value, to the tenth of the unit of the lower limit unless the context clearly dictates otherwise, between the upper and lower limit of that range and any other stated or intervening value in that stated range is encompassed within this disclosure. The upper and lower limits of these smaller ranges may independently be included in the smaller ranges is also encompassed within the invention, subject to any specifically excluded limit in the stated range. Where the stated range includes one or both of the limits, ranges excluding either both of those included limits are also included in this disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the disclosed embodiments, exemplary methods and materials are now described. All publications mentioned herein are incorporated herein by reference to disclose and describe the methods and/or materials in connection with which the publications are cited.

The present disclosure generally relates to garments for indicating proper bodily posture.

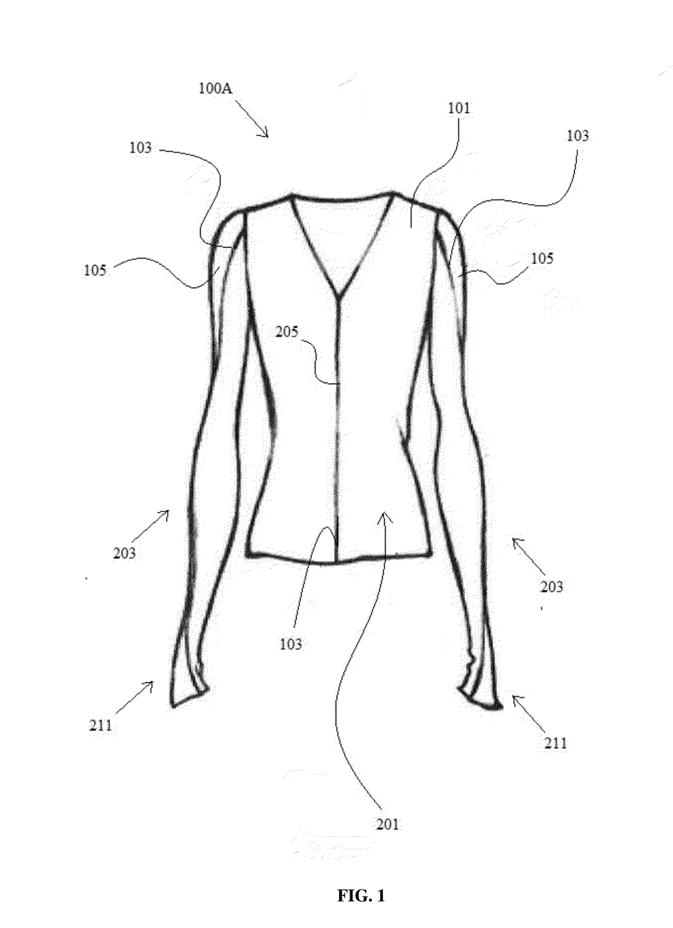

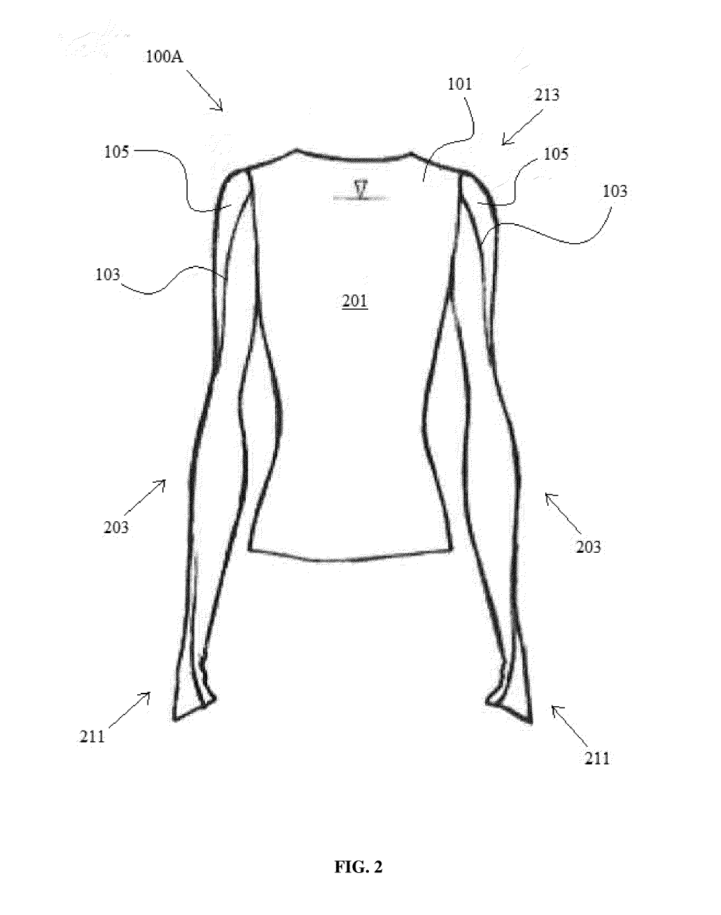

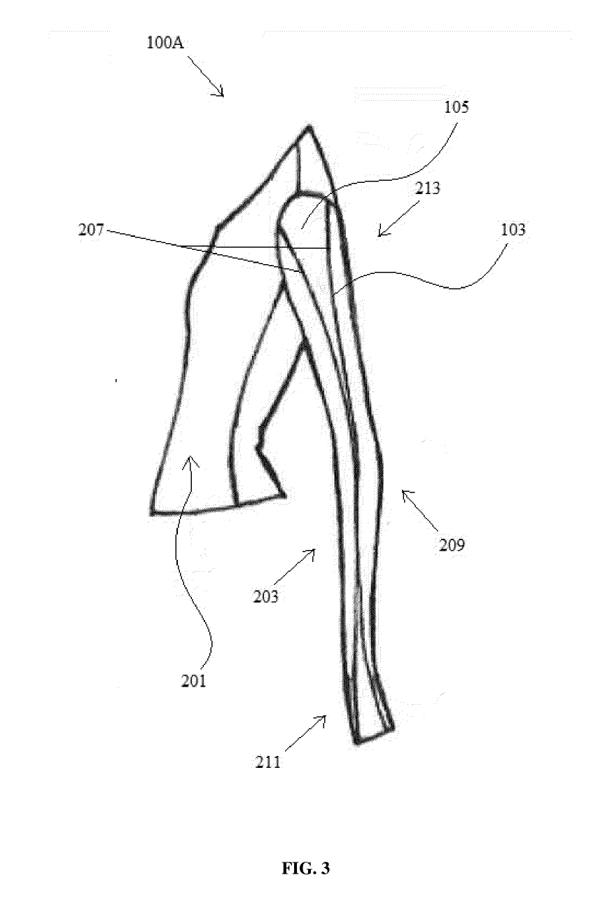

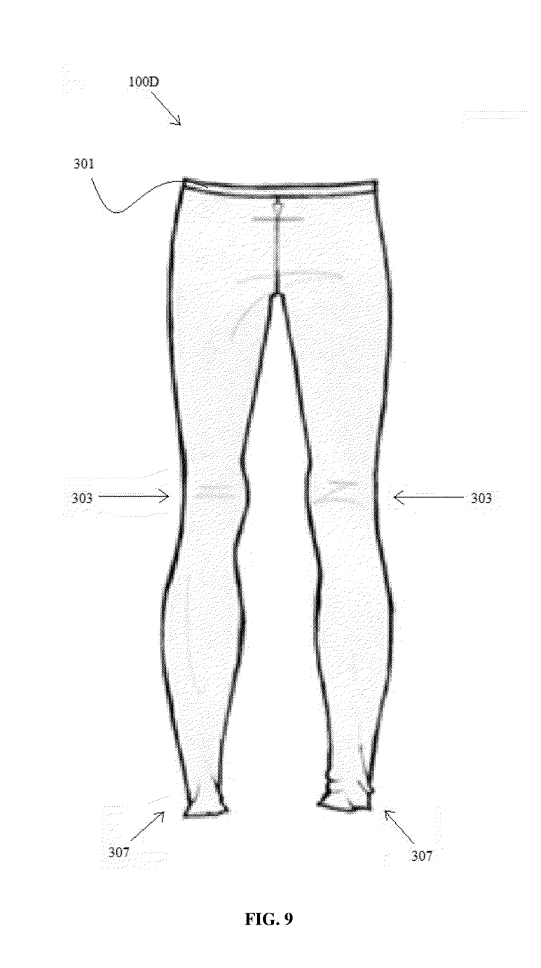

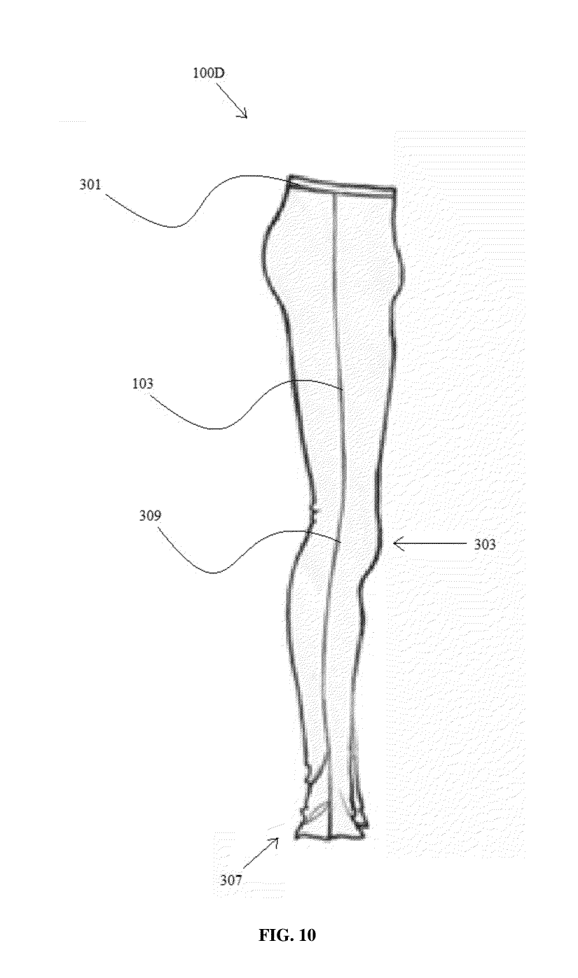

Turning now descriptively to the drawings, in which similar reference characters denote similar elements throughout the several views, FIGS. 1-10 generally depict embodiments of a garment for facilitating bodily posture including a base fabric 101 and at least one reference line 103 disposed on at least a portion of the base fabric 101. The reference line 103 is positioned and configured to indicate a proper bodily posture in at least one position.

In some embodiments, the reference line 103 can be a seam that connects terminus portions of the base fabric 101 and/or a seam that connects terminus portions of the base fabric 101 and another fabric, such as a fabric insert 105.

In some embodiments, the reference lines 103 and the base fabric 101 can contrast in color to stand out from each other for easy visual recognition of the reference lines 103.

The reference lines are configured to indicate bodily alignment/misalignment of an intended activity and/or exercise. In some embodiments, the at least one position can include a plurality of yoga positions such that the reference lines 103 can indicate to a yoga practitioner or instructor that the proper bodily alignment is occurring for a certain pose. For example, the reference lines 103 may be configured to indicate bodily alignment for a single yoga pose (e.g. warrior 2, half-lotus, crane, downward dog, etc.), or for a plurality of poses.

It is contemplated that the reference lines may further be used with additional exercise tools (e.g., a yoga mat with posture lines) to facilitate proper bodily posture. Also, the garment (which includes the reference lines 103) can be configured to account for people of different body sizes and shapes, or the garment can be sized to account for people of different body sizes and shapes.

In some embodiments, the garment can further include one or more fabric inserts 105 connected to the base fabric 101 by one or more seams. It is also envisioned that the fabric inserts 105 and contrast from one or both of the base fabric 101 and the reference lines 103. As described above, reference lines 103 may also be the one or more seams that connect the base fabric 101 and the fabric insert 105. Alternatively, a decal (e.g., Screenprinting) can be placed on base fabric 101 instead of using a fabric insert 105.

Referring specifically to FIGS. 1-3 and FIGS. 6 and 7, the garment can be a shirt 100A, 100C and can further include a torso 201 portion and two sleeves 203. In such embodiments, the reference lines 103 can have a torso reference line 205 in the center of the torso portion 201. Further, the reference lines 103 can also include a pair of sleeve reference lines 207 on each sleeve.

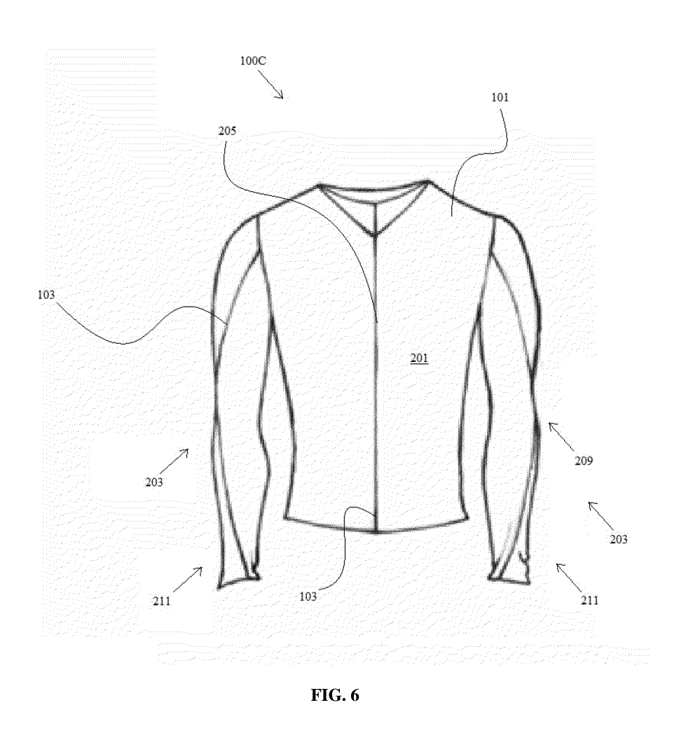

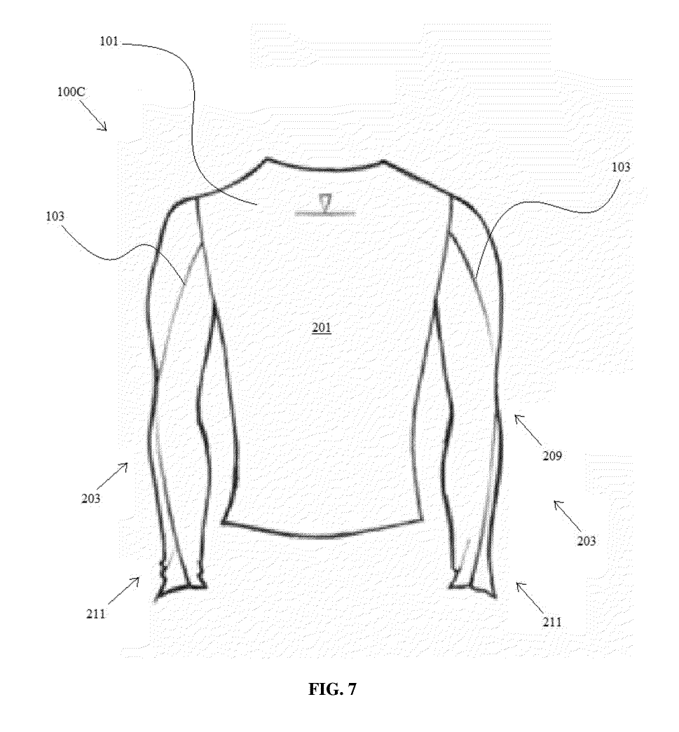

In some embodiments, the reference lines 103 of the pair of sleeve reference lines 207 on each sleeve may converge toward each other at an elbow section 209 of the sleeve and diverge from each other at a wrist portion 211 and/or a shoulder portion 213 of the sleeve 203. The shirts 100A, 100C may be configured for women (FIGS. 1-3) and/or men, respectively (FIGS. 6 and 7).

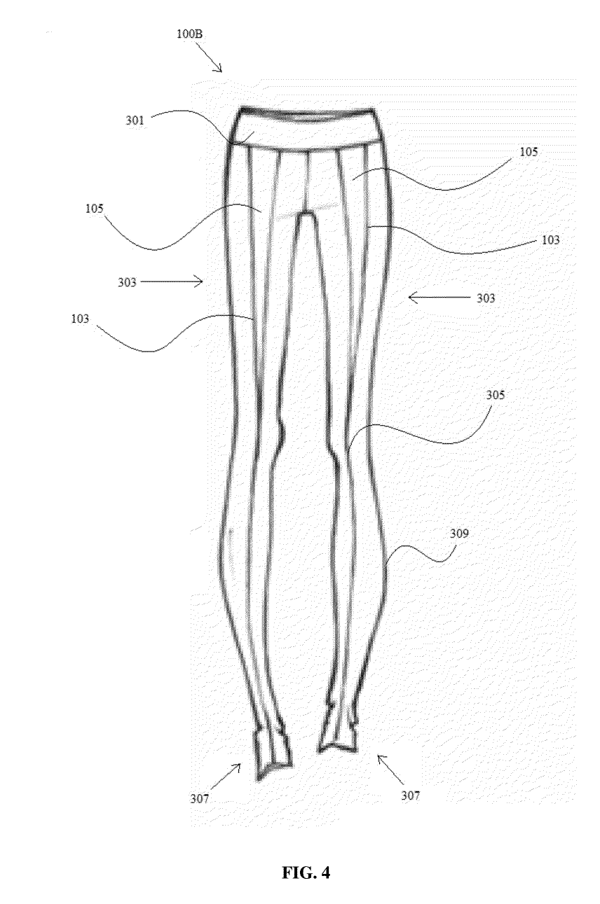

Referring now to FIGS. 4 and 5 and FIGS. 8-10, the garment can also be a pair of pants 100B, 100D that includes a waist portion 301 and two leg portions 303. In such embodiments, the reference line 103 can include a front leg reference line 305 on each leg portion 303 extending from the waist portion 301 to an ankle portion 307 of each leg portion 303 along a front centerline of the leg portion 303. Alternatively or conjunctively, the reference lines 103 can include a side leg reference line 309 on each leg portion 303 extending from the waist portion 301 to an ankle portion 307 of each leg portion 303 along a side centerline of the leg portion 303.

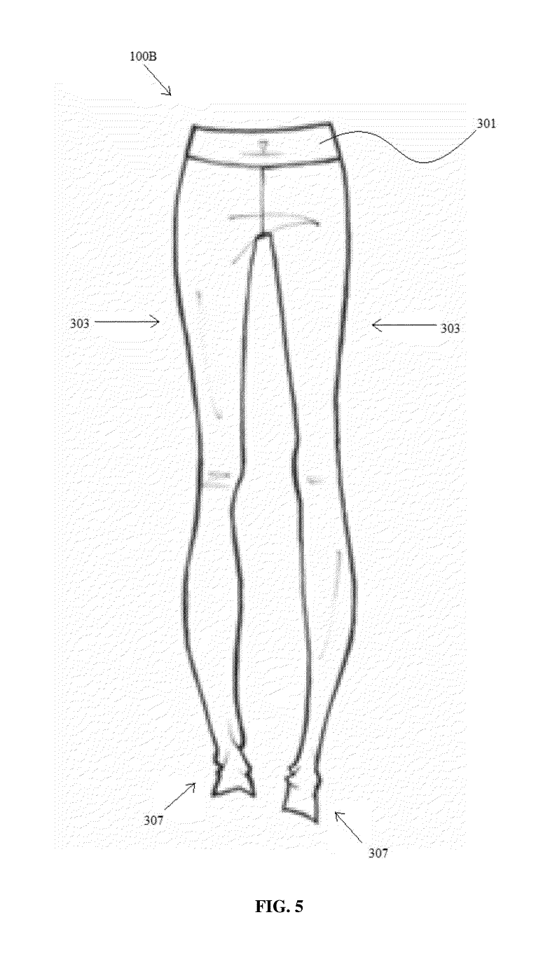

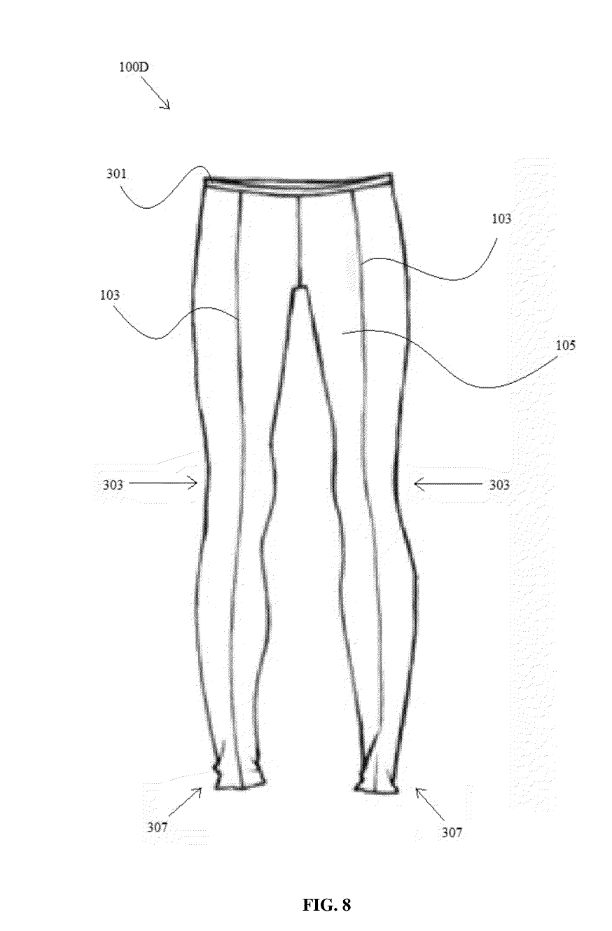

The reference lines front leg reference lines 305 may include a pair of converging reference lines 103 that converge together from the waist portion 301 down to the ankle portion 307 (FIG. 4). The pants 100B, 100D may be configured for women (FIGS. 4 and 5) and/or for men, respectively (FIGS. 8-10).

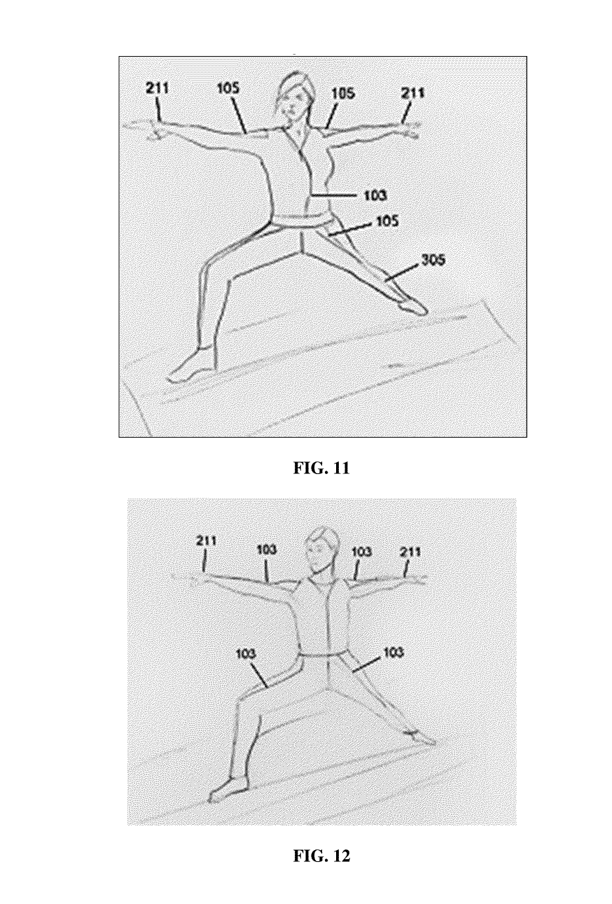

With reference to FIGS. 11 and 12, example methods for using the above described garments are described below. For example, a user may separate their feet and keep their feet parallel. Then, the user may use the fabric insert 105 and front leg reference line 305 to align their thigh, knee, and shin to maintain neutral muscular rotation. Since the thigh, knee, and shin tend to not remain parallel or neutral to the direction of feet, the lining on the garments will allow the user to know when misalignment has occurred.

In another example method, a user may be directed to or independently attempt to supinate their left foot 90 degrees by pivoting the left foot to the left aligning their heel with the arch of their right foot while keeping their torso steady.

A common misalignment is that the users left thigh, knee, and shin internally rotate causing the knee to hyper extend and the arch of the left foot to fall. The user may correct using the fabric insert 105 and front leg reference line 305 to find external rotation in the left leg.

In another example method, a user may be directed to or independently attempt to bend their left knee until it is directly over their left heel. A common misalignment is that the knee is not centered over the heel. In this case, the user can correct using the front leg reference line 305 as a guideline to intersect the middle of the knee over the center of the ankle bone of the user.

In another example method, a user may be directed to or independently attempt to abduct their arms away from the torso with straight elbows until their hands are shoulder height and palms are downward facing. A common misalignment is that the users shoulders collapse internally lacking neutral rotation. In this case, the user can correct using the fabric insert 105, elbow section 209, and wrist portion 211 to find proper external rotation in the upper arm bone and proper internal rotation in the forearm by the line or seam facing directly upwards.

In another example method, a user may be directed to or independently attempt to turn their head to the left looking past their left hand and making sure that their shoulders remain directly over their hips. A common misalignment is that when the users gaze turns forward toward the left hand, the torso tends to follow ahead and/or forward. In this case, to establish correct alignment, the user can return the torso reference line 205 to a vertical position so that their shoulders are over their hips.

The descriptions above and the accompanying drawings should be interpreted in the illustrative and not the limited sense. While the invention has been disclosed in connection with the embodiments disclosed herein, it should be understood that there may be other embodiments which fall within the scope of this disclosure and the following claims. Where a claim, if any, is expressed as a means or step for performing a specified function, it is intended that such claim be construed to cover the corresponding structure, material, or acts described in the specification and equivalents thereof, including both structural equivalents and equivalent structures, material-based equivalents and equivalent materials, and act-based equivalents and equivalent acts.

What is claimed is:

1. A garment for facilitating bodily posture, comprising:
a base fabric;
at least one reference line disposed on at least a portion of the base fabric that is configured to indicate proper bodily posture in at least one position associated with an exercise.

2. The garment of claim 1, wherein the at least one position includes a plurality of yoga positions.

3. The garment of claim 1, wherein the at least one reference line includes a seam.

4. The garment of claim 3, further comprising at least one fabric insert connected to the base fabric by the seam.

5. The garment of claim 1, wherein the reference line and the base fabric contrast in color.

6. The garment of claim 4, wherein the fabric insert contrasts from one or both of the base fabric and the reference line.

7. The garment of claim 1, wherein the garment is a shirt and includes a torso portion and two sleeves.

8. The garment of claim 7, wherein the at least one reference line includes a reference line in the center of the torso portion.

9. The garment of claim 7, wherein the at least one reference line includes a pair of reference lines on each sleeve.

10. The garment of claim 9, wherein the reference lines of the pair of reference lines on each sleeve converge toward each other at an elbow section of the sleeve, wherein the reference lines of the pair of reference lines on each sleeve diverge from each other at a wrist portion and a shoulder portion of the sleeve.

11. The garment of claim 1, wherein the garment is pants and includes a waist portion and two leg portions.

12. The garment of claim 11, wherein the at least one reference line includes a front leg reference line on each leg portion extending from the waist portion to an ankle portion of each leg portion along a front centerline of the leg portion.

13. The garment of claim 11, wherein the at least one reference line includes a side leg reference line on each leg portion extending from the waist portion to an ankle portion of each leg portion along a side centerline of the leg portion.

14. The garment of claim 1, further comprising at least one reference line includes one or more of a decal or screenprint disposed on the base fabric.
